(19) United States
(12) Patent Application Publication
(10) Pub. No.: US 2024/0359596 A1
(43) Pub. Date: Oct. 31, 2024

(54) SYSTEM FOR HEATING A LITHIUM-ION BATTERY USING ALTERNATING CURRENT AND A VEHICLE HAVING THE SAME

(71) Applicant: GM GLOBAL TECHNOLOGY OPERATIONS LLC, DETROIT, MI (US)

(72) Inventors: Suresh Gopalakrishnan, Troy, MI (US); Neeraj S. Shidore, Novi, MI (US); Chandra S. Namuduri, Troy, MI (US); Lei Hao, Troy, MI (US); Satish P. Ketkar, Troy, MI (US); Christian Fau, Northville, MI (US); Lyall Kenneth Winger, Waterloo (CN)

(21) Appl. No.: 18/307,308

(22) Filed: Apr. 26, 2023

(51) Int. Cl. B60L 58/27; H01M 10/0525; H01M 10/46; H01M 10/48; H01M 10/625; H01M 10/657; H02J 7/00; H02J 7/02

(52) U.S. Cl. CPC B60L 58/27; H01M 10/0525; H01M 10/46; H01M 10/486; H01M 10/625; H01M 10/657; H02J 7/007194; H02J 7/02; B60L 2210/10; H01M 2220/20

(57) ABSTRACT

A vehicle having an ambient temperature sensor, a low voltage lithium-ion battery and a controller is provided. The controller is configured to monitor the ambient temperature sensor and based on a determination that an ambient temperature is below a threshold value, provide an alternating current power to the low voltage lithium-ion battery. The alternating current power causes the low voltage lithium-ion battery to heat.

### INTRODUCTION

The disclosure relates to heating a lithium-ion battery using alternating current. More specifically, the disclosure relates to a vehicle having a low voltage lithium-ion battery that is heated using alternating current.

Motor vehicles, both internal combustion and electrically powered, include a low voltage electrical system that is configured to provide power to a wide range of loads in the motor vehicle. The low voltage electrical system typically includes a low voltage battery that provides power to one or more low voltage loads. The most common type of low voltage (i.e., 12V) battery used in cars is a lead-acid battery. Lead-acid batteries have been used for decades and are still widely used due to their high reliability and relatively high energy density. While lithium-ion batteries have a higher charge density than lead-acid batteries (i.e., lithium-ion batteries can store more energy per unit of volume or weight), lead-acid batteries can operate at lower temperatures than lithium-ion batteries, and their performance is less affected by cold temperatures.

### SUMMARY

In one exemplary embodiment, a vehicle is provided. The vehicle includes an ambient temperature sensor, a low voltage lithium-ion battery, and a controller. The controller is configured to monitor the ambient temperature sensor and based on a determination that an ambient temperature is below a threshold value, provide an alternating current power to the low voltage lithium-ion battery. The alternating current power causes the low voltage lithium-ion battery to heat.

In addition to the one or more features described herein the vehicle also includes a bidirectional accessory power module and a high voltage battery electrically connected to the bidirectional accessory power module. The bidirectional accessory power module is configured to generate the alternating current power based on control signals provided by the controller.

In addition to the one or more features described herein the bidirectional accessory power module includes a direct current (DC)-to-DC converter.

In addition to the one or more features described herein the frequency of the alternating current power is determined based on a chemistry of the low voltage lithium-ion battery and a configuration of the low voltage lithium-ion battery.

In addition to the one or more features described herein the frequency of the alternating current power is determined based on the ambient temperature.

In addition to the one or more features described herein the frequency of the alternating current power provided to the low voltage lithium-ion battery is selected to prevent plating of the low voltage lithium-ion battery.

In addition to the one or more features described herein the vehicle also includes a battery temperature sensor configured to measure a temperature of the low voltage lithium-ion battery.

In addition to the one or more features described herein the controller is further configured to monitor the battery temperature sensor and based on a determination that the temperature of the low voltage lithium-ion battery is above a second threshold value, stop providing the alternating current power to the low voltage lithium-ion battery.

In addition to the one or more features described herein the alternating current power is obtained from an electric machine of the vehicle.

In addition to the one or more features described herein the low voltage lithium-ion battery has a capacity of approximately twelve volts.

In one exemplary embodiment, a method for heating a low voltage lithium-ion battery of a vehicle using alternating current is provided. The method includes monitoring an ambient temperature of the vehicle and based on a determination that the ambient temperature of the vehicle is below a first threshold, heating the low voltage lithium-ion battery of the vehicle by providing an AC power to the low voltage lithium-ion battery of the vehicle.

In addition to the one or more features described herein the frequency of the AC power is determined based on a chemistry of the low voltage lithium-ion battery and a configuration of the low voltage lithium-ion battery.

In addition to the one or more features described herein the frequency of the AC power is determined based on the ambient temperature.

In addition to the one or more features described herein the configuration of the low voltage lithium-ion battery includes a number, a size, and a layout of battery cells in the low voltage lithium-ion battery.

In addition to the one or more features described herein the AC power is generated by an accessory power module from high voltage power received from a high voltage battery of the vehicle.

In addition to the one or more features described herein the accessory power module includes a direct current (DC)-to-DC converter.

In addition to the one or more features described herein the method also includes monitoring a temperature of low voltage lithium-ion battery and based on a determination that a temperature of the low voltage lithium-ion battery is above a second threshold, stopping the providing the AC power to a low voltage lithium-ion battery of the vehicle.

In addition to the one or more features described herein the AC power is obtained from an electric machine of the vehicle.

In addition to the one or more features described herein the low voltage lithium-ion battery has a voltage level of approximately twelve volts.

In another exemplary embodiment, a vehicle is provided. The vehicle includes an ambient temperature sensor, a low voltage lithium-ion battery, aa bidirectional accessory power module having a direct current (DC)-to-DC converter, a high voltage battery electrically connected to the bidirectional accessory power module, and a controller. The controller is configured to monitor the ambient temperature sensor and based on a determination that an ambient temperature is below a threshold value, provide an alternating current power to the low voltage lithium-ion battery. The alternating current power causes the low voltage lithium-ion battery to heat and wherein the bidirectional accessory power module is configured to generate the alternating current power based on control signals provided by the controller. The frequency of the alternating current power provided to the low voltage lithium-ion battery is selected to prevent plating of the low voltage lithium-ion battery.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic diagram of a vehicle in accordance with an exemplary embodiment;

FIG. 2A is a block diagram illustrating a portion of an electrical system of a vehicle in accordance with an exemplary embodiment;

FIG. 2B is a block diagram illustrating a portion of an electrical system of a vehicle in accordance with an exemplary embodiment;

FIG. 3 is a flowchart illustrating a method for heating a low voltage lithium-ion battery of a vehicle using alternating current in accordance with an exemplary embodiment; and

FIG. 4 is a flowchart illustrating a method for heating a low voltage lithium-ion battery of a vehicle using alternating current in accordance with an exemplary embodiment.

### DETAILED DESCRIPTION

The following description is merely exemplary in nature and is not intended to limit the present disclosure, its application, or uses. Various embodiments of the disclosure are described herein with reference to the related drawings. Alternative embodiments of the disclosure can be devised without departing from the scope of the claims. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship.

Turning now to an overview of the aspects of the disclosure, embodiments of the disclosure include systems and methods for heating a low voltage lithium-ion battery of a vehicle by passing an alternating current (AC) power through the low voltage lithium-ion battery. In one embodiment, the vehicle is an electric vehicle that includes a high voltage battery, and the AC power is generated by an accessory power module (APM) of the vehicle using power received from the high voltage battery. In another embodiment, the AC power is generated by another AC source, such as an electric motor, within the vehicle. As used herein the term low voltage refers to a voltage of approximately twelve volts and within a range of five to fifteen volts and the term high voltage refers to a voltage of greater than one hundred volts.

In exemplary embodiments, the system for heating a low voltage lithium-ion battery of a vehicle by passing an alternating current (AC) power through the low voltage lithium-ion battery permits the replacement of a lead-acid battery of the vehicle with a low voltage lithium-ion battery, without sacrificing the performance of the battery at low temperatures. In addition, due to the higher charge density of the low voltage lithium-ion battery than the lead-acid battery, the weight and size of the battery needed for the vehicle can be reduced.

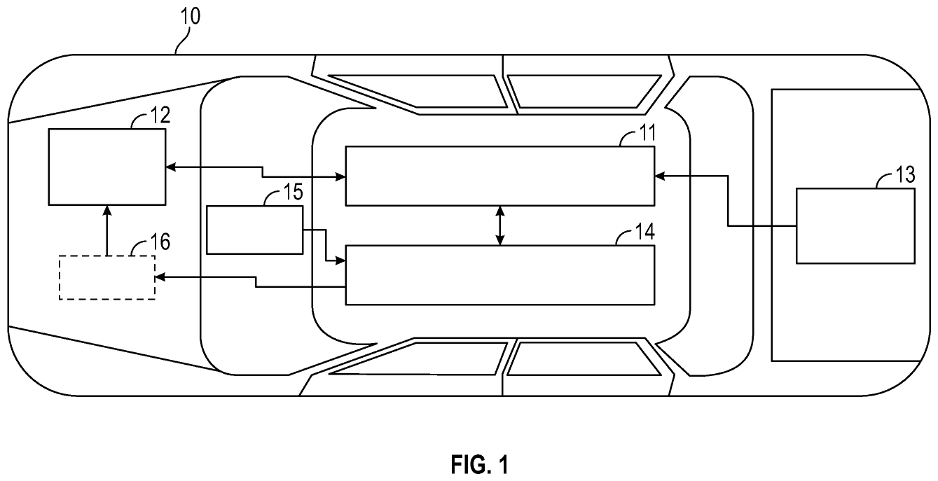

Referring now to FIG. 1, a schematic diagram of a vehicle 10 that includes low voltage lithium-ion battery 12 according to one or more embodiments is shown. The vehicle 10 also includes a high voltage battery 13, an APM 11, a controller 14 and an ambient temperature sensor 15. In some embodiments, the vehicle 10 can also include an AC source 16, such as an electric motor. In exemplary embodiments, the controller 14 is one of a general-purpose processor, a Field programable gate array (FPGA), an application-specific integrated circuit (ASIC), or the like. Controller 14 is configured to monitor the ambient temperature sensor 15. Based on a determination that the ambient temperature of the vehicle 10 is below a threshold value, the controller 14 causes the low voltage lithium-ion battery 12 to be heated by passing an AC power through the low voltage lithium-ion battery 12.

In exemplary embodiments, the AC power that is passed through the low voltage lithium-ion battery 12 is created by the APM 11, based on control signals provided by the controller 14. The APM 11 is configured to receive high voltage direct current power from the high voltage battery 13 and to create an AC power signal. In other embodiments, the AC power that is passed through the low voltage lithium-ion battery 12 is created by the AC source 16, based on control signals provided by the controller 14.

In exemplary embodiments, the form (i.e., the frequency and shape) of the AC power signal created by the APM 11 or the AC source is controlled by the controller 14. The frequency of the AC power signal created is determined by the controller 14 based on one or more of a battery chemistry of the low voltage lithium-ion battery 12, a configuration of the low voltage lithium-ion battery 12, and the ambient temperature of the vehicle. 10.

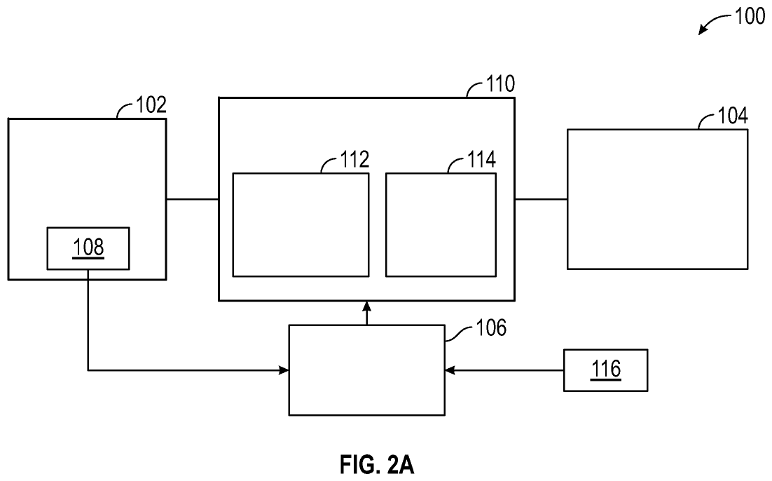

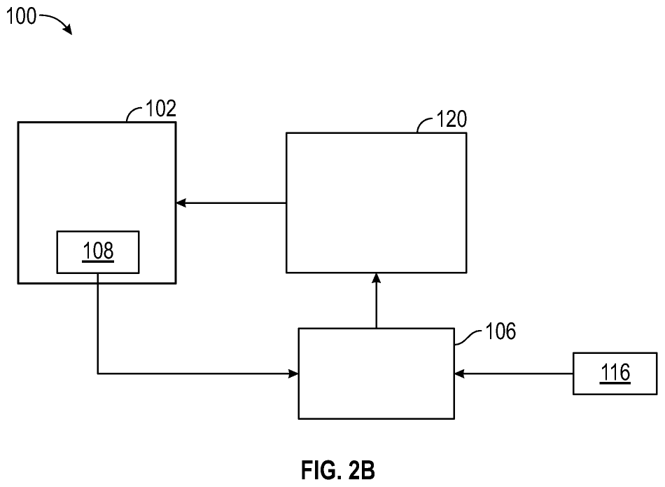

Referring now to FIG. 2A, a block diagram illustrating a portion of an electrical system 100 of a vehicle in accordance with an exemplary embodiment is shown. As illustrated, the electrical system 100 includes a low voltage lithium-ion battery 102 and a high voltage battery 104 that are both electrically connected to an accessory power module (APM) 110. The APM 110 receives a high voltage direct current (DC) from the high voltage battery 104. The DC/DC converter 112 is a transformer that is configured to convert high voltage electricity into a low voltage electricity. The APM includes a bidirectional DC/DC converter 112 and the output voltage profile can be programmed to create an AC power signal that is provided to the low voltage lithium-ion battery 102.

In exemplary embodiments, the form (i.e., the frequency and shape) of the AC power signal created by the APM 110 is controlled by a controller 106. In exemplary embodiments, the controller 106 is one of a general-purpose processor, a field programable gate array (FPGA), an application-specific integrated circuit (ASIC), or the like. Controller 106 is configured to monitor an ambient temperature sensor 116, which is configured to measure an ambient temperature of the environment of the vehicle. Based on a determination that the ambient temperature of the vehicle is below a threshold value, the controller 106 causes the low voltage lithium-ion battery 102 to be heated by instructing the APM 110 to generate the output voltage profile to create an alternating current through the low voltage lithium-ion battery 102. The alternating current could be sinusoidal, trapezoidal, triangular, etc.

In exemplary embodiments, the electrical system 100 also includes a battery temperature sensor 108 that is configured to measure the temperature of the low voltage lithium-ion battery 102. The controller 106 is configured to monitor the battery temperature sensor 108 and to responsively adjust or deactivate the heating of the low voltage lithium-ion battery 102 based on the measured temperature of the low voltage lithium-ion battery 102.

Referring now to FIG. 2B a block diagram illustrating a portion of an electrical system 100 of a vehicle in accordance with an exemplary embodiment is shown. As illustrated, the electrical system 100 includes a low voltage lithium-ion battery 102 and an alternating current (AC) source 120. The electrical system 100 also includes a controller 106 that is configured to monitor an ambient temperature sensor 116, which is configured to measure the ambient temperature of the environment of the vehicle. In exemplary embodiments, the controller 106 is one of a general-purpose processor, a flexible programable gate array (FPGA), an application-specific integrated circuit (ASIC), or the like.

In exemplary embodiments, based on a determination that the ambient temperature of the vehicle is below a threshold value, the controller 106 causes the low voltage lithium-ion battery 102 to be heated by instructing the AC source 120 to create and transmit an AC power signal to the low voltage lithium-ion battery 102. In exemplary embodiments, the form (i.e., the frequency and shape) of the AC power signal created by the AC source is controlled by a controller 106. In exemplary embodiments, the electrical system 100 also includes a battery temperature sensor 108 that is configured to measure the temperature of the low voltage lithium-ion battery 102. The controller 106 is configured to monitor the battery temperature sensor 108 and to responsively adjust or deactivate the heating of the low voltage lithium-ion battery 102 based on the measured temperature of the low voltage lithium-ion battery 102.

In exemplary embodiments, the form of the AC power signal includes a frequency of the AC power and a shape of the AC power signal. The shape can include a sinusoidal waveform, a triangular waveform, a square waveform, or a trapezoidal waveform. In exemplary embodiments, the shape of the waveform of the AC power signal is determined at least based in part on the type of device creating the AC power signal. For example, in embodiments where an APM is creating the AC power signal a square or trapezoidal waveform is selected. In contrast, in embodiments where an AC source is creating the AC power signal a sinusoidal waveform is selected.

In exemplary embodiments, the frequency of the AC power is determined based on one or more of a chemistry of the low voltage lithium-ion battery and a configuration of the low voltage lithium-ion battery. The frequency is selected to be greater than a threshold level that is determined based on a frequency below at which the low voltage lithium-ion battery would experience plating. In addition, the frequency of the AC power is determined based on the ambient temperature of the vehicle. Accordingly, as the ambient temperature of the vehicle changes, the frequency of the AC power will also change.

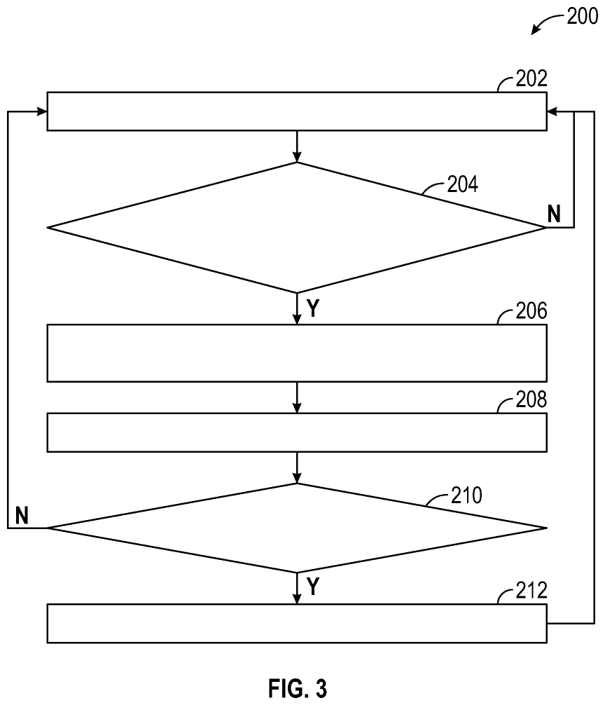

Referring now to FIG. 3, a flowchart illustrating a method 200 for heating a low voltage lithium-ion battery of a vehicle using alternating current in accordance with an exemplary embodiment is shown. In exemplary embodiments, the method 200 is performed by a controller 14 such as the one shown in FIG. 1. At block 202, the method 200 includes monitoring an ambient temperature of a vehicle. Next, at decision block 204, the method includes determining whether the ambient temperature is less than the first threshold temperature and the lithium-ion battery temperature is less than a second threshold. In exemplary embodiments, the first threshold temperature is approximately negative thirty degrees Celsius (−30° C.). In exemplary embodiments, the first threshold temperature is determined based on the chemistry of a low voltage lithium-ion battery of the vehicle.

Based on a determination that the ambient temperature is less than a first threshold temperature and the lithium-ion battery temperature is less than the second threshold, the method 200 proceeds to block 206 and includes providing AC power to a low voltage lithium-ion battery of the vehicle, which causes heating of the low voltage lithium-ion battery. In exemplary embodiments, the frequency of the AC power provided to the low voltage lithium-ion battery is based at least in part on the ambient temperature of the vehicle.

During the heating of the low voltage lithium-ion battery, the method 200 includes monitoring a temperature of the lithium-ion battery at block 208. Next, at decision block 210, the method 200 includes determining whether the temperature of the lithium-ion battery is greater than a third threshold value. In exemplary embodiments, the third threshold temperature is approximately negative five degrees Celsius (−5° C.). In exemplary embodiments, the third threshold temperature is determined based at least in part on the chemistry of a low voltage lithium-ion battery of the vehicle.

Based on a determination that the temperature of a low voltage lithium-ion battery is less than the third threshold temperature, the method 200 returns to block 202. Once the temperature of a low voltage lithium-ion battery exceeds the third threshold temperature, the method 200 proceeds to block 212 and stops providing the AC power to the lithium-ion battery.

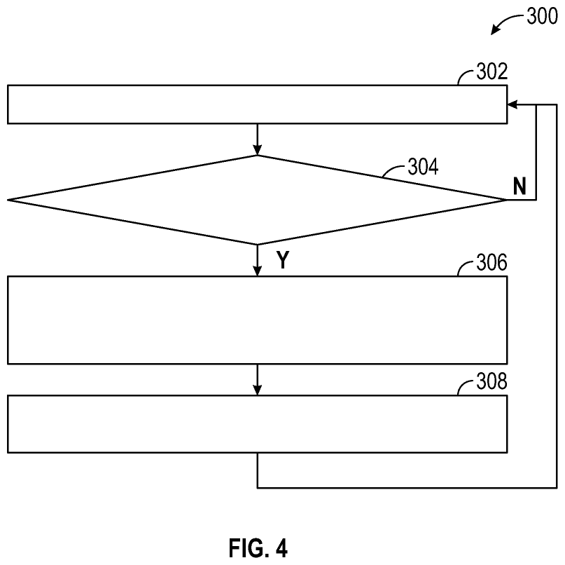

Referring now to FIG. 4, a flowchart illustrating a method 300 for heating a low voltage lithium-ion battery of a vehicle using alternating current in accordance with an exemplary embodiment is shown. In exemplary embodiments, the method 300 is performed by a controller 14 such as the one shown in FIG. 1. At block 302, the method 300 includes monitoring an ambient temperature of a vehicle. Next, at decision block 304, the method includes determining whether the ambient temperature is less than the first threshold temperature. In exemplary embodiments, the first threshold temperature is approximately negative thirty degrees Celsius (−30° C.). In exemplary embodiments, the first threshold temperature is determined based on the chemistry of a low voltage lithium-ion battery of the vehicle.

Based on a determination that the ambient temperature is less than a first threshold temperature, the method 300 proceeds to block 306 and includes obtaining characteristics of a low voltage lithium-ion battery of the vehicle and determining a frequency of an AC power based on the ambient temperature and the characteristics. In exemplary embodiments, the characteristics of the low voltage lithium-ion battery include a chemistry of the low voltage lithium-ion battery and a configuration of the low voltage lithium-ion battery. The configuration of the low voltage lithium-ion battery includes a number, size, and layout of battery cells in the low voltage lithium-ion battery. Next, at block 308, the method 300 includes providing the AC power to the low voltage lithium-ion battery of the vehicle, which causes the low voltage lithium-ion battery to heat.

In exemplary embodiments, a low voltage lithium-ion battery is smaller, in both volume and weight, than a low voltage lead-acid battery with approximately the same charge capacity. Accordingly, replacing the low voltage lead-acid battery with a low voltage lithium-ion battery will result in a reduction in the weight of the vehicle and a reduction in the space of the vehicle that is required to house the low voltage battery.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs. While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
an ambient temperature sensor; and
a low voltage lithium-ion battery;
a controller configured to:
monitor the ambient temperature sensor; and
based on a determination that an ambient temperature is below a threshold value, provide an alternating current power to the low voltage lithium-ion battery,
wherein the alternating current power causes the low voltage lithium-ion battery to heat.

2. The vehicle of claim 1, further comprising:
a bidirectional accessory power module; and
a high voltage battery electrically connected to the bidirectional accessory power module,
wherein the bidirectional accessory power module is configured to generate the alternating current power based on control signals provided by the controller.

3. The vehicle of claim 2, wherein the bidirectional accessory power module includes a direct current (DC)-to-DC converter.

4. The vehicle of claim 1, wherein a frequency of the alternating current power is determined based on a chemistry of the low voltage lithium-ion battery and a configuration of the low voltage lithium-ion battery.

5. The vehicle of claim 4, wherein the frequency of the alternating current power is determined based on the ambient temperature.

6. The vehicle of claim 4, wherein the frequency of the alternating current power provided to the low voltage lithium-ion battery is selected to prevent plating of the low voltage lithium-ion battery.

7. The vehicle of claim 1, further comprising a battery temperature sensor configured to measure a temperature of the low voltage lithium-ion battery.

8. The vehicle of claim 7, wherein the controller is further configured to:
monitor the battery temperature sensor; and
based on a determination that the temperature of the low voltage lithium-ion battery is above a second threshold value, stop providing the alternating current power to the low voltage lithium-ion battery.

9. The vehicle of claim 1, wherein the alternating current power is obtained from an electric machine of the vehicle.

10. The vehicle of claim 1, wherein the low voltage lithium-ion battery has a capacity of approximately twelve volts.

11. A method for heating a low voltage lithium-ion battery of a vehicle using alternating current, the method comprising:
monitoring an ambient temperature of the vehicle; and
based on a determination that the ambient temperature of the vehicle is below a first threshold, heating the low voltage lithium-ion battery of the vehicle by providing an AC power to the low voltage lithium-ion battery of the vehicle.

12. The method of claim 11, wherein a frequency of the AC power is determined based on a chemistry of the low voltage lithium-ion battery and a configuration of the low voltage lithium-ion battery.

13. The method of claim 12, wherein the frequency of the AC power is determined based on the ambient temperature.

14. The method of claim 12, wherein the configuration of the low voltage lithium-ion battery includes a number, a size, and a layout of battery cells in the low voltage lithium-ion battery.

15. The method of claim 11, wherein the AC power is generated by an accessory power module from high voltage power received from a high voltage battery of the vehicle.

16. The method of claim 15, wherein the accessory power module includes a direct current (DC)-to-DC converter.

17. The method of claim 11, further comprising:
monitoring a temperature of low voltage lithium-ion battery; and
based on a determination that a temperature of the low voltage lithium-ion battery is above a second threshold, stopping the providing the AC power to a low voltage lithium-ion battery of the vehicle.

18. The method of claim 11, wherein the AC power is obtained from an electric machine of the vehicle.

19. The method of claim 11, wherein the low voltage lithium-ion battery has a voltage level of approximately twelve volts.

20. A vehicle comprising:
an ambient temperature sensor;
a low voltage lithium-ion battery;
a bidirectional accessory power module having a direct current (DC)-to-DC converter;
a high voltage battery electrically connected to the bidirectional accessory power module; and
a controller configured to:
monitor the ambient temperature sensor; and
based on a determination that an ambient temperature is below a threshold value, provide an alternating current power to the low voltage lithium-ion battery,
wherein the alternating current power causes the low voltage lithium-ion battery to heat and wherein the bidirectional accessory power module is configured to generate the alternating current power based on control signals provided by the controller, and
wherein a frequency of the alternating current power provided to the low voltage lithium-ion battery is selected to prevent plating of the low voltage lithium-ion battery.
